(19) United States
(12) Patent Application Publication
(10) Pub. No.: US 2023/0145788 A1
(43) Pub. Date: May 11, 2023

(54) VEHICLE EQUIPMENT SEAL DEVICE

(71) Applicant: Systems & Technology Corp., New Taipei City (TW)

(72) Inventors: Ming-Chuan LAN, New Taipei City (TW); Chang-Jung LEE, New Taipei City (TW); Ming-Chuan WU, New Taipei City (TW)

(21) Appl. No.: 17/942,372

(22) Filed: Sep. 12, 2022

(30) Foreign Application Priority Data
Nov. 8, 2021 (TW) 110213139

(51) Int. Cl. E05B 47/00; E05B 67/00; E05B 83/02

(52) U.S. Cl. CPC E05B 47/0012; E05B 67/003; E05B 83/02; E05B 2047/0017; E05B 2047/0067; E05B 2047/0058

(57) ABSTRACT

A vehicle equipment seal device includes a main body portion, a bolt portion, a metal wire connection portion and a lock structure. The main body portion has a connection surface. The bolt portion is inserted into the main body portion. The metal wire connection portion has one end fixed on the connection surface of the main body portion, and the other end provided with the bolt portion. The lock structure is arranged in the main body portion, wherein the lock structure includes a motor and a sensor, and the sensor is used to position a turning position of the motor, thereby determining whether the lock structure locks the bolt portion or unlocks the bolt portion.

### 1. FIELD OF THE DISCLOSURE

The present disclosure relates too a vehicle equipment seal device and, more particularly, to a vehicle equipment seal device with high security.

### 2. DESCRIPTION OF RELATED ART

With the development of the economy, the logistics industry is also booming. For the logistics industry, how to deliver the goods safely is one of the most important challenges. To prevent the goods from stealthy substitution or theft during transportation, the door of the container or packing box that contains the goods will generally be locked and sealed to be secured, and the integrity of the seal will be used to judge whether the goods are safe or not. However, prior seals not only may be damaged during transportation, but also may be easily forged, Therefore, the use of prior seals to secure the safety of goods transportation cannot satisfy the actual requirements.

Furthermore, with the development of communication and electronic technology, the prior seals are gradually replaced by the electronic seals, wherein the electronic seal has functions such as communication, locking and unlocking, so that electronic seal can be locked and unlocked by means of electronic communication for achieving high security. However, the electronic seal generally makes use of the magnetic reed switch connection as the removal-proof structure. Since the magnetic reed switch is easily affected by external magnetic force, the electronic seal may have a misjudgment and the removal-proof effect becomes invalid. In addition, the electronic seal is generally locked to the container or the packing box by using padlocks, bolts, rope locks and the like without special fixation, which will cause the electronic seal to easily collide with the container or packing box thereby damaging the parts of the electronic seal, and even the electronic seal may be easily shaken and turned over, resulting in poor antenna reception and affecting the communication quality. In addition, the electronic seal generally makes use of the rotation number of the motor as the positioning to lock/unlock the lock device. However, with the increase of use time, the magnetic force of the motor is attenuated, which is easy to cause the reduction of the rotation number. Therefore, the use of the existing electronic seals is not satisfactory.

Therefore, it is desirable to provide an improved vehicle equipment seal device to mitigate and/or obviate the aforementioned problems.

### SUMMARY

The present disclosure provides a vehicle equipment seal device, which not only has stable communication quality and is not affected by external magnetic force, but also does not affect the normal locking/unlocking function of the lock device clue to the attenuation caused by the increase in the use time of the motor.

To achieve the aforementioned purpose, the vehicle equipment seal device of the present disclosure includes: a main body portion having a connection surface; a bolt portion for being inserted into the main body portion; a metal wire connection portion having one end fixed on the connection surface of the main body portion, and the other end provided with the bolt portion; and a lock structure arranged in the main body portion, wherein the lock structure has a motor and a sensor, so that the sensor is used to position a turning position of the motor thereby determining whether the lock structure locks the bolt portion or unlocks the bolt portion.

Other objects, advantages, and novel features of the disclosure will become more apparent from the following detailed description when taken in conjunction with the accompanying drawings.

### BRIEF DESCRIPTION OF THE DRAWINGS

FIG. 1 shows a vehicle equipment seal device of the present disclosure.

FIG. 2 shows the magnetic attraction surface of the main body portion of the vehicle equipment seal device according to the present disclosure.

FIG. 3 shows the second side surface of the main body portion of the vehicle equipment seal device according to the present disclosure.

FIG. 4 shows the lock structure in the main body portion of the vehicle equipment seal device according to the present disclosure.

FIG. 5 shows a schematic diagram of the lock structure configured to a locked state.

FIG. 6 shows a schematic diagram of the lock structure changed to an unlocked state.

### DETAILED DESCRIPTION

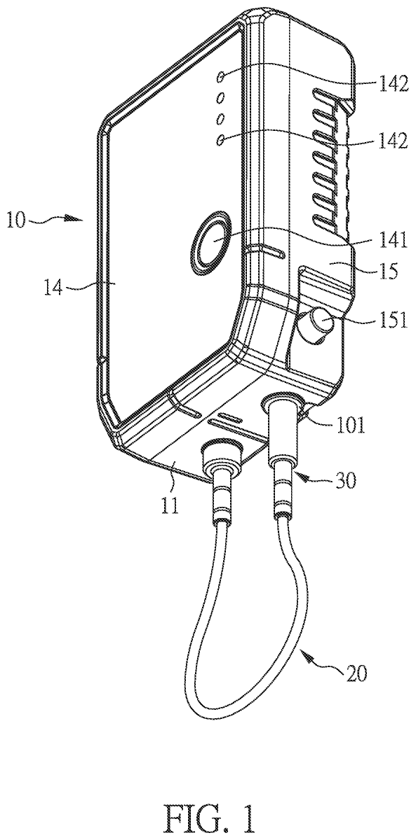

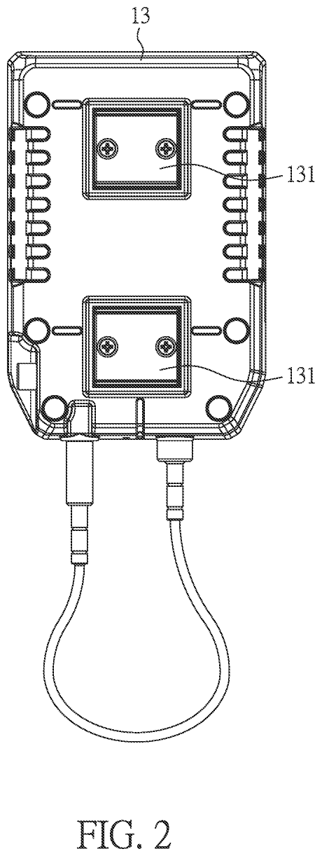

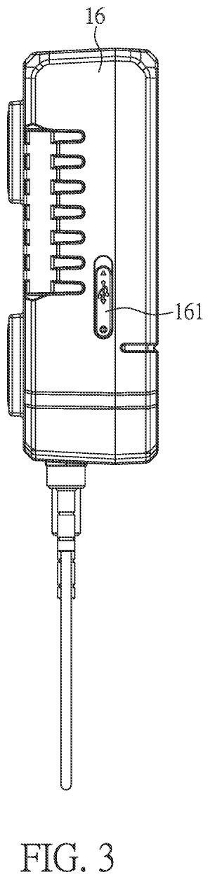

FIG. 1 shows the vehicle equipment seal device of the present disclosure, which includes a main body portion 10, a metal wire connection portion 20, and a bolt portion 30. With reference to FIG. 1, as well as FIGS. 2 and 3 described in details below, the main body portion 10 is substantially a rectangular box constituted by a connection surface 11, an indication surface 14, a magnetic attraction surface 13 (shown in FIG. 2) opposite to the indication surface 14, a first side surface 15, and a second side surface 16 (shown in FIG. 3) opposite to the first side surface 15. The metal wire connection portion 20 is formed by a high-strength metal wire, such as a steel wire. One end of the metal wire connection portion 20 is fastened to the connection surface 11 of the main body portion 10, and the other end thereof is provided with the bolt portion 30. The bolt portion 30 can be inserted into a bolt hole 101 on the connection surface 11 of the main body portion 10, so that the bolt portion 30 can be locked to the main body portion 10 to achieve the effect of a seal.

FIG. 2 shows the magnetic attraction surface 13 of the main body portion 10 of the vehicle equipment seal device according to the present disclosure, wherein the magnetic attraction surface 13 is provided with at least one magnet 131. In this embodiment, the magnetic attraction surface 13 is provided with two high-strength magnets 131. With the high-strength magnets 131, the vehicle equipment seal device can be attached on the container or the packing box without encountering the problem of collision and overturning, so that the durability of the components of the vehicle equipment seal device can be improved and the communication quality is stable.

With reference to FIG. 1 again, the aforementioned first side surface 15 is provided with an unlock button 151, which can be pressed to unlock the vehicle equipment seal device when confirming a state of safety, so that the bolt portion 30 can be separated from the main body portion 10 through the bolt hole 101.

FIG. 3 shows the second side surface 16 of the main body portion 10 of the vehicle equipment seal device according to the present disclosure, wherein the second side surface 16 is provided with a USB port 161 for connecting a USB device to perform data transmission or connecting a USB charger to charge the vehicle equipment seal device.

With reference to FIG. 1 again, the aforementioned indication surface 14 is provided with a button 141 and a plurality of indicator lights 142. The button 141 can be pressed to perform electric related functions such as functional testing and power display, and the indicator lights 142 are used to display the power status, communication status, positioning status and locking status of the vehicle equipment seal device.

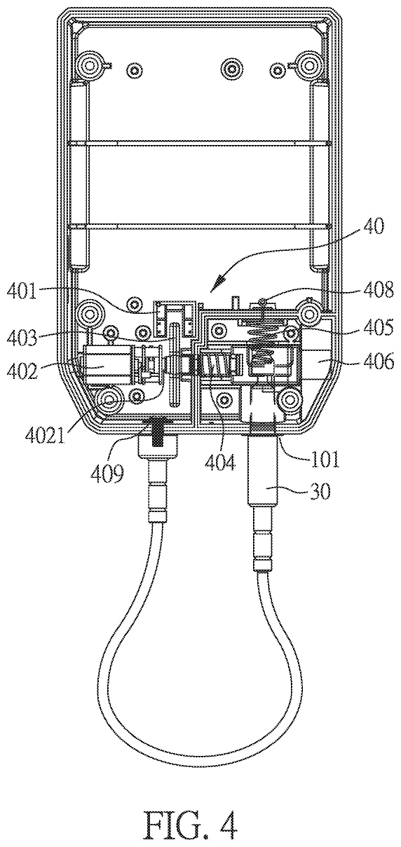

A lock structure 40 is further provided in the main body portion 10 for locking the bolt portion 30 or unlocking the bolt portion 30. FIG. 4 shows the lock structure 40 in the main body portion 10 of the vehicle equipment seal device according to the present disclosure, wherein the lock structure 40 includes a sensor 401, a motor 402, a blocking piece 403, a movable pin 404, a conduction connection spring 405, and a latching slider 406.

The blocking piece 403 is arranged on the rotation shaft 4021 of the motor 402. The motor 402 can rotate and drive the blocking piece 403 to turn with its rotation shaft 4021 and, in cooperation with the sensing of the sensor 401, enable the blocking piece 403 to be disposed in a first position or a second position. The sensor 401 is arranged to be adjacent to the blocking piece 403 for sensing the movement of the blocking piece 403 and positioning the blocking piece 403, wherein the blocking piece 403 will block the movable pin 404 from moving toward the motor 402 when the blocking piece 403 is in the first position, and the blocking piece 403 will not block the movable pin 404 from moving toward the motor 402 when the blocking piece 403 is in the second position.

The latching slider 406 is arranged corresponding to the movable pin 404 for pushing the movable pin 404 to move. The movable pin 404 is arranged such that one end thereof corresponds to the blocking piece 403 and the rotation shaft 4021 of the motor 402, and the other end thereof corresponds to the latching slider 406 and is operatively connected to the latching slider 406. With the elasticity of the movable pin 404, the latching slider 406 can latch the bolt portion 30 that is inserted into the bolt hole 101. The conduction connection spring 405 is arranged to enable the bolt portion 30 that is inserted into the bolt hole 101 to be connected with the first conduction point 408, or to enable the bolt portion 30 to be separated from the first conduction point 408.

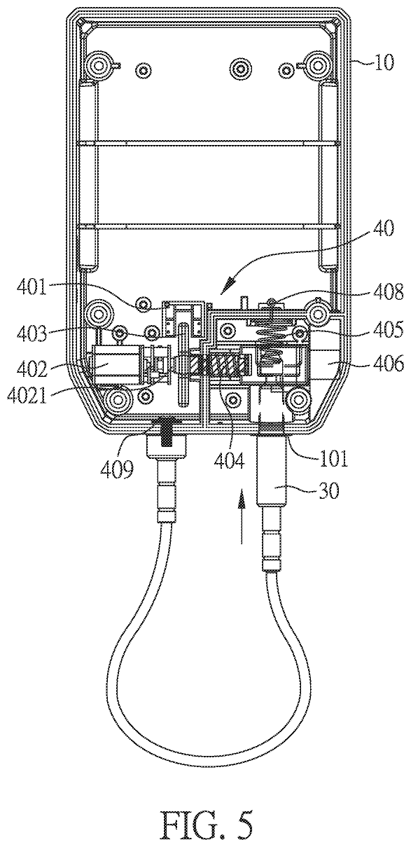

FIG. 5 shows a schematic diagram of the lock structure 40 configured to a locked state, wherein the bolt portion 30 is first inserted into the main body portion 10 through the bolt hole 101 so that the bolt portion 30 will be latched by the latching slider 406, and the end of the bolt portion 30 will press against the conduction connection spring 405. Since the bolt portion 30 is formed by a conductive metal wire, an electrical connection can be formed between the first conduction point 408 and the second conduction point 409 and, at this moment, the vehicle equipment seal device can be locked through communication setting. By starting the motor 402 to drive the blocking piece 403 to turn, and cooperating with the sensing of the sensor 401, the blocking piece 403 can be disposed in the first position to block the movable pin. 404, so that the latching slider 406 cannot be pushed toward the movable pin 404 and the motor 402. Therefore, the bolt portion 30 is fixed and latched by the latching slider 406 to be in a locked state, so that the bolt portion 30 cannot be removed from the main body portion 10 through the bolt hole 101, thereby completing the locking and alarm setting for the lock structure 40.

In the locked state of the lock structure 40, the first conduction point 408 and the second conduction point 409 are conducted through the metal wire connection portion 20. With the use of the high-strength metal wire for conduction, the lock structure 40 is not easily affected by external influence to cause system misjudgment. In addition, when the bolt portion 30 is removed or destroyed or the metal wire connection portion 20 is cut without turning off the locking alarm, the conduction state between the conduction point A and the conduction point B is destroyed, and thus the vehicle equipment seal device will be triggered to issue an alarm, such as generating a warning sound and notifying the cargo carrier and the remote control center by means of wireless communication, thereby providing better security.

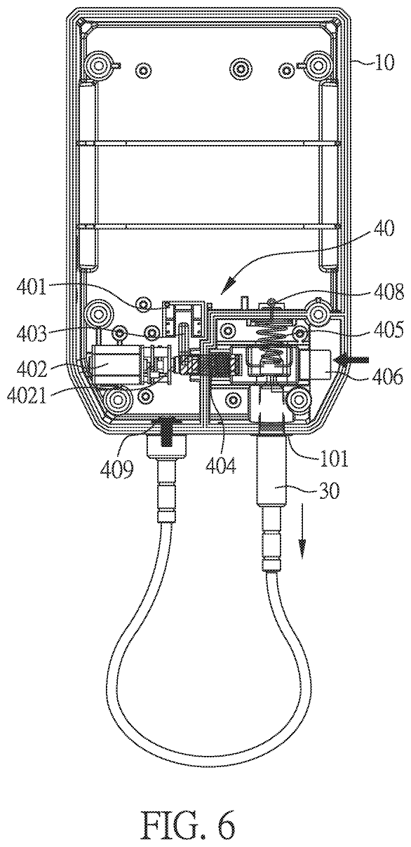

FIG. 6 shows a schematic diagram of the lock structure 40 changed to an unlocked state. When the locking alarm of the lock structure 40 is turned off, the motor 402 is activated to drive the blocking piece 403 to turn and, in cooperation with the sensing of the sensor 401, enable the blocking piece 403 to be disposed in the second position, so as not to block the movable pin 404, such that the latching slider 406 can move toward the movable pin 404 and the motor 40 thereby breaking off the electrical connection between the first conduction point 408 and the second conduction point 409. At this moment, the unlock button 151 can be pressed to unlock the vehicle equipment seal device, wherein the unlock button 151 is arranged corresponding to the latching slider 406. When the unlock button 151 is pressed, the latching slider 406 is pushed to move toward the movable pin 404 and the motor 402, so that the movable pin 404 also moves toward the motor 40. Therefore, the bolt portion 30 can be released by the latching slider 406 to present an unlocked state, and the bolt portion 30 can be removed from the main body portion 10 through the bolt hole 101 due to the elastic three of the conduction connection spring 405.

During the turning and positioning of the motor 402 in the locked state and the unlocked state of the lock structure 40, the sensor 401 is used to sense the turning position of the motor 402, so as to determine the locking and unlocking of the lock structure 40. Because of using the sensor 401 for determination, it is able to prevent the normal locking/unlocking function of the lock structure 40 from being affected by the attenuation caused by the increased use time of the motor 402.

The aforementioned embodiments are examples only for convenience of description. The scope of the present disclosure is claimed hereinafter in the claims and is not limited to the embodiments.

What is claimed is:

1. A vehicle equipment seal device, comprising:
a main body portion having a connection surface;
a bolt portion for being inserted into the main body portion;
a metal wire connection portion having one end fixed on the connection surface of the main body portion, and the other end provided with the bolt portion; and
a lock structure arranged in the main body portion, wherein the lock structure includes a motor and a sensor, and the sensor is used to position a turning position of the motor, thereby determining whether the lock structure locks the bolt portion or unlocks the bolt portion.

2. The vehicle equipment seal device of claim 1, wherein the main body portion further has a magnetic attraction surface, and at least one magnet is arranged on the magnetic attraction surface.

3. The vehicle equipment seal device of claim 1; wherein the lock structure further includes a blocking piece, a movable pin, a conduction connection spring and a latching slider.

4. The vehicle equipment seal device of claim 3, wherein the blocking piece is arranged on a rotation shaft of the motor, and the motor rotates and drives the blocking piece to turn with the rotation shaft, and cooperates with sensing of the sensor to enable the blocking piece to be disposed in a first position or a second position.

5. The vehicle equipment seal device of claim 4, wherein the sensor is arranged to be adjacent to the blocking piece to sense movement of the blocking piece and position the blocking piece.

6. The vehicle equipment seal device of claim 4, wherein the blocking piece blocks the movable pin from moving toward the motor when the blocking piece is disposed in the first position, and the blocking piece does not block the movable pin from moving toward the motor when the blocking piece is disposed in the second position.

7. The vehicle equipment seal device of claim 4, wherein the latching slider is arranged corresponding to the movable pin for pushing the movable pin to move.

8. The vehicle equipment seal device of claim 7, wherein the movable pin is arranged to have one end corresponding to the blocking piece and the rotation shaft of the motor, and the other end corresponding to the latching slider and cooperatively connected to latching slider.

9. The vehicle equipment seal device of claim 8, wherein the latching slider latches the bolt portion inserted into the main body portion by elasticity of the movable pin.

10. The vehicle equipment seal device of claim 9, wherein the conduction connection spring is arranged to enable the bolt portion inserted into the main body portion to be connected with a first conduction point, or to enable the bolt portion to be separated from the first conduction point.
